(19) United States
(12) Patent Application Publication
(10) Pub. No.: US 2015/0166710 A1
(43) Pub. Date: Jun. 18, 2015

(54) METHOD FOR PRODUCING POLYMERS OF VINYL AROMATICS, AS WELL AS VINYL AROMATIC-DIENE BLOCK COPOLYMERS

(71) Applicant: STYROLUTION EUROPE GMBH, Frankfurt am Main (DE)

(72) Inventors: Konrad Knoll, Mannheim (DE); Ulrike Dardin, Laudenbach (DE)

(21) Appl. No.: 14/409,275

(22) PCT Filed: Jun. 24, 2013
(86) PCT No.: PCT/EP2013/063097

§ 371 Date: Dec. 18, 2014

(30) Foreign Application Priority Data
Jun. 26, 2012 (EP) 12173528.6

(51) Int. Cl. C08F 293/00; C08F 212/08

(52) U.S. Cl. CPC C08F 293/00; C08F 212/08

(57) ABSTRACT

Process for the production of vinylaromatic homo- or block copolymers via anionic polymerization, where the polymerization of a vinylaromatic uses a modified n-alkyllithium initiator which is obtainable via reaction, at a temperature of from −20 to 100° C., of n-alkyllithium, dissolved in an inert solvent, with a diene in a molar ratio of from 1:1 to 1:50.

The present invention relates to a process for the production of polymers from vinylaromatics, and also of vinylaromatic-diene block copolymers, with the aid of a modified n-alkyllithium initiator, and to use thereof as initiator for the anionic polymerization reaction.

Block copolymers of vinylaromatics (e.g. styrene) and dienes (e.g. butadiene) are copolymers made of a plurality of polymer molecule regions (known as blocks) linked to one another in series or linked in any other way, where the blocks have relatively uniform structure within themselves. In accordance with structure and content of diene monomers they can—at any particular temperature—have a property profile that is overall elastomeric or a property profile that is overall rigid and non-elastomeric, i.e. they either exhibit elastomeric behavior overall in relation to their external environment, in a manner similar to that of a polydiene, and are important by way of example as what are known as thermoplastic elastomers, or they behave like transparent, tough and rigid styrene polymers. Conventional terminology, with reference to the terminology used for impact-modified polystyrene, uses the term soft phase for those molecular portions that determine the elastomeric behavior, and the term hard phase for the rigid molecular portions (the fraction consisting only of polystyrene). In contrast to this, styrene-diene copolymers of entirely random structure, known as SB rubbers, cannot be processed like thermoplastics, but instead must be vulcanized like conventional diene polymers before use, i.e. must be crosslinked, and this greatly increases processing time for these.

U.S. Pat. No. 3,992,483 discloses that primary alkyllithium initiators, specifically n-BuLi (n-butyllithium), which has relatively low reactivity, require activation for the anionic polymerization of monovinylaromatic compounds, for example styrene in cyclohexane, with use of a 1,1-dialkylethylene promoter such as 2-methyl-1-pentene or isobutene. The document also says that a broad molar ratio distribution of the type that occurs in n-BuLi-initiated styrene polymerization without activator, leads to poor mechanical properties. The disadvantage of this process consists in the relatively large quantities required of activator, a commonly used range for these being stated as from 150 to 1000 times the mass of alkyllithium. During the return and distillative purification of the solvent, usually cyclohexane, it must be removed. Another serious disadvantage is that, because of the low boiling point, it disrupts the conventional evaporative cooling between the individual polymerization steps.

EP-A 242 612 discloses the sequential anionic polymerization of, preferably, styrene and butadiene via initiation with n-butyllithium in the presence of small quantities of THF [=tetrahydrofuran] (from 0.01 to 1% by weight). The disadvantage of this process is a marked increase in the number of 1,2-linkages of at least from 3 to 5% during the subsequent butadiene polymerization, leading to a higher glass transition temperature, i.e. poorer elastomer properties, and to increased oxidation- and crosslinking-susceptibility.

WO-A-95/35335 discloses the production of thermoplastic elastomers with sec-butyllithium as initiator in cyclohexane. The styrene polymerization under these conditions gives the desired, mechanically advantageous narrowly distributed living polymers, but sec-butyl-lithium is more expensive than n-BuLi, and especially at room temperature is not stable in storage. A pyrophoric lithium hydride slurry is formed, with liberation of butene, and ignites spontaneously on contact with air.

It was therefore an object of the present invention to eliminate the abovementioned disadvantages.

Accordingly, a novel and improved process has been found for the production of polymers from vinylaromatics, and also of vinylaromatic-diene block copolymers.

The invention provides a process for the production of vinylaromatic homopolymers, and also of vinylaromatic-diene block copolymers via anionic polymerization, characterized in that the polymerization of a vinylaromatic uses a modified n-alkyllithium initiator which is obtainable via reaction, at a temperature of from −20 to 100° C., of n-alkyllithium, dissolved in an inert solvent, with a diene in a molar ratio of from 1:1 to 1:50.

The expression modified alkyllithium initiator in the invention means an alkyllithium initiator generally comprising from 1 to 50, preferably from 1 to 20, in particular from 1 to 10, particularly preferably from 1 to 5, and very particularly preferably from 1 to 3, monomer units of a diene polymerized into the molecule.

The following dienes are suitable for the production of the modified alkyllithium initiator used in the invention: 1,3-dienes, preferably 1,3-butadiene, isoprene, 2,3-dimethylbutadiene, and/or 1,3-pentadiene, particularly preferably 1,3-butadiene. C₁-C₂₂-lithium, preferably C₄-C₈-alkyllithium, particularly preferably n-butyllithium, is suitable as n-alkyl-lithium.

The reaction of the diene with n-alkyllithium can preferably be carried out in the presence of an inert solvent.

The reaction of the diene with n-alkyllithium can be carried out without addition of any activator. In this connection, the term activators means polar aprotic compounds such as ethers (e.g. THF) or tertiary amines (e.g. tributylamine, pyridine).

n-Alkyllithium is used in the form of solution of n-alkyllithium in an inert solvent, the usual concentration of the solution being from 0.1 to 20% by weight, preferably from 1 to 15% by weight, particularly preferably from 5 to 13% by weight. By way of example, n-butyllithium solutions obtainable commercially generally take the form of 12% by weight solutions.

For the production of the modified alkyllithium initiator used in the process of the invention, it is advantageous to use the n-alkyllithium solution, optionally with addition of further inert solvent, as initial charge and then to add the diene at temperatures of from −20 to 100° C., preferably from 20 to 80° C., particularly preferably from 35 to 75° C., in particular from 50 to 75° C., and at a pressure of from 0.5 to 100 bar, preferably from 1 to 10 bar, particularly preferably from 2 to 5 bar, optionally with addition of an inert solvent.

The reaction generally takes place under inert gas. It is moreover advantageous to provide rapid mixing of the reaction mixture by using a high-speed stirrer, e.g. a propeller stirrer. Apparatuses that are likewise suitable are mixing chambers which have no moving parts and through which the mixture flows continuously, where the two reaction components are injected under pressure into the chambers in a manner that leads to rapid turbulent mixing.

Examples of suitable inert solvents are aliphatic and/or aromatic hydrocarbons, e.g. C₅— to C₂₀-alkane such as n-pentane, isopentane, n-hexane, isohexane, heptane, octane, or isooctane, a C₄— to C₂₀-cycloalkane such as cyclobutane, cyclopentane, cyclohexane, cycloheptane, cyclooctane, methylcyclohexane, and decalin, aromatics and alkylaromatics such as benzene, toluene, ortho-, meta- and para-xylene, ethylbenzene, n- and isopropylbenzene, tert-butylbenzene, naphthalene, methylnaphthalene, and tetralin, and also mixtures of these. Preference is given to use of cyclohexane or a mixture of cyclohexane and n-hexane. Preference is further given to mixtures of cyclohexane with an inert solvent having a melting point <4° C.

The insert solvents that are used for the n-alkyl-lithium solution and for further dilution thereof, or for the dilution of the diene, can be identical or different, preferably being identical.

It is preferable to carry out the reaction under inert gas. Suitable inert gases are nitrogen, noble gases such as argon, helium, neon, krypton, xenon, or hydrocarbons such as methane, ethane, propane, butane, or hydrogen, preferably nitrogen or argon, particularly preferably nitrogen.

The ratio by volume of inert solvent to the n-alkyl-lithium solution is generally from 0:1 to 10:1, preferably from 0.1:1 to 8:1, particularly preferably from 0.5:1 to 2:1, in particular 1:1.

The ratio by volume of inert solvent to diene is generally from 0:1 to 10:1, preferably from 0.1:1 to 8:1, particularly preferably from 0.5:1 to 2:1, in particular 1:1.

It is preferable that no additional inert solvent is added to the usual n-alkyllithium solution described above.

If no additional inert solvent is added, the ratio by volume of inert solvent to diene is generally from 0.5:1 to 2:1, preferably from 0.7:1 to 1.5:1, particularly preferably 1:1.

The molar ratio of n-alkyllithium to diene is generally from 1:1 to 1:50, with preference from 1:1 to 1:20, preferably from 1:1 to 1:10, with particular preference from 1:1.2 to 1:5, and with very particular preference from 1:1.5 to 1:3.

The modified alkyllithium initiator obtainable as described above, used in the process of the invention, should in essence be free from monomeric diene, i.e. the concentration of monomeric diene in relation to the initiator is generally from 0 to 1000 ppm, preferably from 0 to 100 ppm, particularly preferably from 0 to 10 ppm.

The modified alkyllithium initiator obtained can optionally be placed into intermediate storage under inert gas, or used directly for the process of the invention. For storage, the initiator is by way of example cooled to temperatures that are preferably below 60° C. by passage through a heat exchanger, following production.

The anionic homo- or copolymerization of vinylaromatic monomers is known (see K. Knoll in Kunststoffhandbuch Polystyrol [Plastics Handbook Polystyrene]: volume 4, Gausepohl and Gellert, eds., Hanser Verlag, 1996, pp. 145-160). The production of block copolymers based on vinylaromatic units and on diene monomer units via sequential anionic polymerization is likewise known (ibid pp. 161-164). The abovementioned processes are expressly incorporated herein by way of reference.

In the process of the invention, the modified alkyllithium initiator is reacted in an inert solvent such as, preferably, cyclohexane with a vinylaromatic such as, preferably, styrene at temperatures of from 0 to 120° C., preferably from 20 to 100° C., particularly preferably from 30 to 90° C., in particular from 35 to 80° C., and at a pressure of from 0.3 to 25 bar, preferably from 0.5 to 5 bar, particularly preferably from 0.5 to 2 bar.

Suitable vinylaromatics are styrene, α-methylstyrene, o-, m-, p-substituted alkylstyrenes, vinylnaphthalene and/or 1,1-diphenylethylene, preferably styrene, α-methylstyrene, o-, m-, p-substituted alkylstyrenes such as o-, m- and/or p-methylstyrene, particularly preferably styrene. The process of the invention can use one vinylaromatic or else a plurality of different vinylaromatics.

In one preferred embodiment it is possible to add the modified alkyllithium initiator under the abovementioned conditions to a mixture of an inert solvent such as cyclohexane and a vinylaromatic such as, preferably, styrene. In another possibility here, the modified alkyllithium initiator is added directly after production thereof, while it is still warm or hot.

The process of the invention can give narrowly distributed, linear polymer chains of the vinylaromatic which are living, i.e. amenable to further polymerization, i.e. are active and therefore reactive, and which by way of example can be reacted in a following polymerization step with a diene or a mixture of a vinylaromatic such as styrene and a diene.

It is preferable that the sequential anionic polymerization takes the form of block polymerization of a vinylaromatic and a diene.

Dienes suitable for the block polymerization reaction are 1,3-dienes, preferably 1,3-butadeiene, isoprene, 2,3-dimethylbutadiene, and/or 1,3-pentadiene, particularly preferably 1,3-butadiene and isoprene, very particularly preferably 1,3-butadiene. The process of the invention can use one diene or else a plurality of different dienes.

It is preferable that the sequential anionic polymerization reaction takes the form of block polymerization of styrene and 1,3-butadiene.

Without addition of any randomizer, addition of a mixture of a vinylaromatic and a diene to the living polymer chain gives a diene block with a blurred transition to a subsequent vinylaromatic block. Examples of randomizers that can be used are THF and potassium alcoholates (e.g. potassium tert-amyl alcoholate).

Addition of a randomizer can give a random vinylaromatic/diene block when a mixture of a vinylaromatic and a diene is added to the living polymer chain. If a randomizer of potassium alcoholate type is used in the process of the invention, a suitable potassium to lithium ratio is preferably in the range from 1:30 to 1:40, particularly preferably 1:37.

The number, length, sequence, and composition of the blocks can be selected as desired.

The process of the invention is particularly suitable for the production of vinylaromatic-diene block copolymers having at least one external vinylaromatic block.

At the end of the polymerization reaction, a proton donor, for example alcohols, preferably isopropanol, or water, can be added to protonate and thus deactivate the polymer chain, or a bi- or oligofunctional coupling agent can be added to give a symmetrical linear polymer of doubled molar mass or a star polymer. In another variant it is possible, after one or more polymerization steps, to make one or more further additions of the modified alkyllithium initiator followed by monomer, thus giving a bi- or oligomodal molar mass distribution. If an oligofunctional coupling agent is admixed with the living polymer chains, asymmetrical star polymers are obtained.

The modified alkyllithium initiator is by way of example stable at 60° C., and can also be stored in the form of solution under inert gas for subsequent use.

The vinylaromatic homo- and block copolymers produced with the aid of the initiator used in the invention are generally transparent, and can, as determined by their composition, behave as elastomers or have the mechanical properties of a tough, rigid material.

The invention further provides the use, as initiator for the anionic polymerization of vinylaromatics, of modified n-alkyllithium comprising from 1 to 50, preferably from 1 to 20, in particular from 1 to 10, particularly preferably from 1 to 5, and very particularly preferably from 1 to 3, monomer units of a diene polymerized into the molecule.

### EXAMPLES

Chemicals used:

Styrene from BASF SE

n-Butyllithium (12% by weight) in cyclohexane/n-hexane

mixture from Chemetall

Butadiene from BASF SE

The styrene derives from the styrene distillation process of the styrene factory, and was used without further purification, an aluminum oxide column was used to dry the cyclohexane at room temperature, and aluminum oxide was used at −10° C. for drying of, and removal of stabilizer from, the butadiene.

The GPC measurements were made in accordance with DIN 55672 with use of an ERC-RI-101 refractive index detector.

For each inventive example and comparative example, a 10 1 stainless steel autoclave equipped for simultaneous heating and cooling and provided with a cross-blade stirrer was prepared by flushing with nitrogen and scalding with cyclohexane/sec-BuLi.

Cyclohexane was then charged, and the quantities stated in the respective examples of initiator and monomers and optionally further solvent were added.

The temperature of the reaction mixture was controlled via heating or cooling of the reactor jacket. The usual methods were used for subsequent work-up. Once the reaction had ended, isopropanol was added to protonate the carbon ions.

### Comparative Example 1

Styrene polymerization with n-BuLi; theoretical number-average molar mass of the styrene polymer Mₙ=50 000 g/mol

4487 ml of cyclohexane were used as initial charge and heated to 70° C. 18.75 ml of n-butyllithium (1.6 M) were then added. 1655 ml of styrene were then added over 30 minutes. After a continued reaction time of 30 minutes to give complete polymerization, 1.5 ml of isopropanol were then added for protic termination of the active chain ends.

The solids content of the sample was 30% by weight.

GPC measurement gave the following data:

Mₙ (number average): 46 898 g/mol

M_{W} (weight average): 57 113 g/mol

D (polydispersity): 1.22

Mₚ (peak maximum): 70 528 g/mol

The GPC plot reveals a bimodal molar mass distribution.

### Inventive Example 1

Styrene polymerization with modified n-butyllithium initiator (n-BuLi reacted with 5 equivalents of butadiene for activation), theoretical number-average molar mass of the styrene polymer Mₙ=50 000 g/mol

1282 ml of cyclohexane were used as initial charge and heated to 60° C. 18.75 ml of n-butyllithium (1.6 M) and 12.4 ml of butadiene (5 equivalents) were then added; 25 minutes were allowed for these to be consumed in the reaction before a further 3205 ml of cyclohexane were added and the reaction temperature was swiftly increased to 70° C. 1655 ml of styrene were then added over 30 minutes. After a continued reaction time of 30 minutes to give complete polymerization, 1.5 ml of isopropanol were then added for protic termination of the active chain ends.

The solids content of the sample was 30% by weight.

GPC measurement gave the following data:

Mₙ (number average): 44 858 g/mol

M_{W} (weight average): 51 535 g/mol

D (polydispersity): 1.14

Mₚ (peak maximum): 52 442 g/mol

The GPC plot reveals a monomodal distribution.

### Comparative Example 2

Styrene polymerization with n-BuLi; theoretical number-average molar mass of the styrene polymer Mₙ=10 000 g/mol

4487 ml of cyclohexane were used as initial charge and heated to 35° C. 93.8 ml of n-butyllithium (1.6 M) were then added. 1655 ml of styrene were then added over 2 minutes; this was allowed to polymerize adiabatically until reaction was complete. The maximum temperature was 96° C. 1.5 ml of isopropanol were then used for protic termination of the active chain ends.

The solids content of the sample was 30% by weight.

GPC measurement gave the following data:

Mₙ (number average): 11 770 g/mol

M_{W} (weight average): 19 956 g/mol

D (polydispersity): 1.70

Mₚ (peak maximum): 26 740 g/mol

### Inventive Example 2

Styrene polymerization with modified n-butyllithium initiator (n-BuLi reacted with 10 equivalents of butadiene for activation), theoretical number-average molar mass of the styrene polymer Mn=10 000 g/mol 1282 ml of cyclohexane were used as initial charge and heated to 75° C. 93.8 ml of n-butyllithium (1.6 M) and 25 ml of butadiene (10 equivalents) were then added in 2 equal portions, the second portion being added after 15 minutes; about 25 minutes were allowed for this to be consumed in the reaction before a further 3205 ml of cyclohexane were added and the reaction temperature was swiftly lowered to 40° C. 1655 ml of styrene were then added over 2 minutes; this was allowed to polymerize adiabatically until reaction was complete. The maximum temperature was 94° C. 1.5 ml of isopropanol were then used for protic termination of the active chain ends. The solids content of the sample was 30% by weight.

GPC measurement gave the following data:

Mₙ (number average): 10 921 g/mol

M_{W} (weight average): 16 808 g/mol

D (polydispersity): 1.54

Mₚ (peak maximum): 21 188 g/mol

Summary: The results (inventive examples 1 and 2) show that styrene polymers obtained by using the modified n-butyllithium initiator have markedly narrower distribution than when n-BuLi is used as in the prior art.

1.-7. (canceled)

8. A process for the production of vinylaromatic block copolymers via anionic polymerization, characterized in that the polymerization of a vinylaromatic uses a modified n-alkyllithium initiator which is obtainable via reaction, at a temperature of from −20 to 100° C., of n-alkyl-lithium, dissolved in an inert solvent, with a 1,3-diene in a molar ratio of from 1:1 to 1:10, and where the anionic polymerization is carried out sequentially as block polymerization of a vinylaromatic and a diene, where a polymerization step that follows comprises reaction of a diene or of a mixture of vinylaromatics and a diene.

9. The process for the production of vinylaromatic block copolymers as claimed in claim 8, characterized in that a modified n-alkyllithium initiator is used which comprises from 1 to 5 monomer units of a diene polymerized into the molecule.

10. The process for the production of vinylaromatic block copolymers as claimed in claim 8, characterized in that a modified n-alkyllithium initiator is used which comprises from 1 to 3 monomer units of a diene polymerized into the molecule.

11. The process as claimed in claim 8, characterized in that a modified n-butyllithium initiator is used.

12. The process as claimed in claim 10, characterized in that a modified n-butyllithium initiator is used.

13. The process as claimed in claim 8, characterized in that styrene is the vinylaromatic and 1,3-butadiene is the diene.

14. The process as claimed in claim 10, characterized in that styrene is the vinylaromatic and 1,3-butadiene is the diene.

15. The process as claimed in claim 11, characterized in that styrene is the vinylaromatic and 1,3-butadiene is the diene.

16. An anionic polymerization of vinylaromatics having as an initiator a modified n-alkyllithium comprising from 1 to 10 monomer units of a 1,3-diene polymerized into the molecule.
